(19) United States
(12) Patent Application Publication
(10) Pub. No.: US 2025/0211493 A1
(43) Pub. Date: Jun. 26, 2025

(54) APPARATUS AND METHOD FOR TOPOLOGY DESIGN IN DISTRIBUTED LEARNING

(71) Applicant: HUAWEI TECHNOLOGIES CO., LTD., Shenzhen (CN)

(72) Inventors: Septimia SARBU, Boulogne Billancourt (FR); Abdellatif ZAIDI, Boulogne Billancourt (FR)

(73) Assignee: HUAWEI TECHNOLOGIES CO., LTD., Shenzhen (CN)

(21) Appl. No.: 19/080,514

(22) Filed: Mar. 14, 2025

Related U.S. Application Data
(63) Continuation of application No. PCT/EP2022/075589, filed on Sep. 15, 2022.

(51) Int. Cl. H04L 41/12; H04L 41/0893; H04L 41/14

(52) U.S. Cl. CPC H04L 41/12; H04L 41/0893; H04L 41/145

(57) ABSTRACT

Described is a device (1000) in a network for performing inference for a hierarchy of tasks, the network comprising multiple nodes (206, 207, 208, 209, 210, 211, 1050) each configured to process respective data relating to a task of the hierarchy of tasks, the device being configured to: send (801) a respective current collaboration pattern (203, 204) to each node in the network, each respective current collaboration pattern being derived from a current connectivity model (202, 205, 601) for the network indicating which other node(s) in the network a respective node is to communicate with; receive (802) a respective vector of losses corresponding to the hierarchy of tasks from each node in the network; and form (803) an updated connectivity model for the network in dependence on the received respective vectors of losses. This may allow the determination of an optimal network topology for a given hierarchy of tasks.

### CROSS-REFERENCE TO RELATED APPLICATIONS

This is a continuation of International Patent Application No. PCT/EP2022/075589, filed on Sep. 15, 2022, the disclosure of which is hereby incorporated by reference in its entirety.

### FIELD OF THE INVENTION

This disclosure relates to data processing, for example to distributed learning and inference in a network of data processing devices.

### BACKGROUND

The main class of methods to solve many distributed learning problems is represented by Federated Learning, where a main node, generally termed the parameter server, has much larger amounts of memory and processing power than the edge devices in the network, generally termed the clients, to perform computations and store results. In addition, the parameter server orchestrates the communication of the information exchanges that take place in the network throughout the training and inference phases.

The connectivity pattern of the clients is termed the network topology. A large variety of patterns of the topology are possible. However, the most common one is the star topology, as schematically illustrated in FIG. 1 (a). In this network topology, for network 100, the communication takes place only between the parameter server 101 and each node 102, 103, 104, 105, 106, 107 and these connections remain fixed during the entire phases of both training and inference.

The communication patterns in the network can be defined by a connectivity matrix (CM), as shown in FIG. 1 (b). The collaboration pattern of the devices in the network can therefore be stored as a matrix whose rows and columns indicate an index of the device and which contains the numbers 1 and 0 as its elements. For example, an element equal to 1 at row i and column j indicates that devices i and j exchange information. A value of 0 indicates that the corresponding devices do not communicate in the current round of message exchanges. The connectivity matrix shown in FIG. 1 (b) is a full connectivity matrix where each node communicates with each of the other nodes in the network.

For the case of independent and identically distributed (i.i.d.) data at the clients, meaning that the data has the same statistical characteristics throughout the network, a star network architecture performs very well, while reducing the communication overhead to a minimum. However, this becomes highly suboptimal in real-world applications, where data does not possess homogeneous properties.

The main disadvantage of prior techniques in this field is that they generally assume that the data is i.i.d and thus the large majority of Federate Learning algorithms are tailored to this case. When they are applied to the non-i.i.d. case, the learning performance can drop to unacceptable levels.

To ensure the same performance as in the i.i.d case, more flexibility is required in the design of the collaboration patterns of the devices in such a network processing non-i.i.d. data. In addition, to achieve optimality of performance and resource consumption, it is desirable to tailor the network topology to the particular tasks or the hierarchical composition of tasks that the network aims to solve.

### SUMMARY OF THE INVENTION

According to one aspect, there is provided a device in a network for performing inference for a hierarchy of tasks, the network comprising multiple nodes each configured to process respective data relating to a task of the hierarchy of tasks, the device being configured to: send a respective current collaboration pattern to each node in the network, each respective current collaboration pattern being derived from a current connectivity model for the network indicating which other node(s) in the network a respective node is to communicate with; receive a respective vector of losses corresponding to the hierarchy of tasks from each node in the network; and form an updated connectivity model for the network in dependence on the received respective vectors of losses.

The approach may provide an efficient way to determine the optimal network topology for a given hierarchy of tasks. The approach can be used in image classification applications to provide a customized network topology which can ensure a high accuracy of image classification on each device in the network. The approach can also address the non-i.i.d. and private nature of data and multitask inference.

Each respective vector of losses may be determined in dependence on one or more gradients of respective neural networks implemented by a respective node in the network and each of the nodes in the network that are configured to communicate with the respective node according to the current connectivity model for the network. This may allow for model and performance improvement and preserve privacy of the data.

The updated connectivity model may define multiple clusters of nodes, wherein each node in a cluster is configured to communicate with other nodes in that cluster. Each node in a cluster may be configured to communicate only with other nodes in that cluster. The connectivity model may be, for example, a connectivity matrix. This may allow for each cluster of nodes to be obtained in such a way as to exploit the data that has similar statistical properties and pertains to a specific task from the hierarchy of tasks. This may result in improved inference performance and communication efficiency.

The updated connectivity model may further define an inter-cluster collaboration pattern for each of the multiple clusters of nodes. This may allow for efficient communication between clusters.

The nodes of a cluster may each be configured to output data that is relevant for a same task of the hierarchy of tasks. This may result in improved inference performance and communication efficiency. The latter may be achieved because the clustering may allow only nodes that have relevant data to exchange information between themselves.

The respective data processed by each node in the network may be non-independent and identically distributed data having different statistical properties depending on which node in the network the data is processed by. This may reflect many real-world applications where data does not possess homogeneous properties.

The device may be further configured to: combine the respective vectors of losses received from each of the nodes in the network to determine a value of combined losses; and form the updated connectivity model in dependence on the value of combined losses. This may allow the loss received from each of the nodes in the network to be used to update the connectivity model.

The device may be configured to form the updated connectivity model so as to minimize a global average training loss for the hierarchy of tasks. This may allow the connectivity model to be optimized as the network moves towards convergence.

According to a second aspect, there is provided a node in a network for performing inference for a hierarchy of tasks, the network comprising multiple nodes each configured to implement a respective neural network for processing respective data relating to a task of the hierarchy of tasks, the node being configured to: receive a current collaboration pattern from a device in the network, the current collaboration pattern being derived from a current connectivity model for the network indicating which other node(s) in the network the node is to communicate with; determine one or more gradients of the respective neural network implemented by the node; send the one or more gradients to one or more other nodes in the network indicated by the current collaboration pattern; determine a vector of losses corresponding to the hierarchy of tasks; and send the vector of losses to the device.

The approach may provide an efficient way to determine the optimal collaboration patterns for nodes in a network for a given hierarchy of tasks using information provided by the nodes. The approach can also address the non-i.i.d. and private nature of data and multitask inference, as a node can exchange only gradients with other nodes and not raw input data.

The node may be further configured to: receive one or more gradients of the respective neural network(s) implemented by one or more other nodes in the network as defined by the current connectivity model for the network; and determine the vector of losses corresponding to the hierarchy of tasks in dependence on the received one or more gradients. This may allow for model and performance improvement and preserve privacy of the data.

The node may be configured to update parameters of its neural network in dependence on the one or more gradients received from the one or more other nodes in the network as defined by the current connectivity model for the network. This may allow each node to optimize its own neural network and may allow for compatibility with existing methods such as stochastic gradient descent.

The node may be further configured to receive an updated collaboration pattern from the device, the updated collaboration pattern indicating other nodes in a cluster with which the node is to communicate. This may allow the nodes in the network to communicate such they can exploit the data that has similar statistical properties and pertains to a specific task from the hierarchy.

The node may be configured to send the output of its neural network to the other nodes in the cluster indicated by the updated collaboration pattern. This may result in improved inference performance and communication efficiency because only node devices that have relevant data exchange information between themselves.

The node may be configured to process data relevant to a task in the hierarchy of tasks. This may allow the nodes in the network to communicate such they can exploit the data that has similar statistical properties and pertains to a specific task from the hierarchy. This may allow the hierarchy of tasks to be solved using distributed learning and inference.

The data processed by the node may be non-independent and identically distributed data having different statistical properties to data processed by one or more other nodes in the network. This may reflect many real-world applications where data does not possess homogeneous properties.

According to a further aspect, there is provided a computer-readable storage medium having stored thereon computer-readable instructions that, when executed at a computer system located at the device or the node, cause the computer system to perform the steps set out above. The computer system may comprise one or more processors. The computer-readable storage medium may be a non-transitory computer-readable storage medium.

### BRIEF DESCRIPTION OF THE FIGURES

The present disclosure will now be described by way of example with reference to the accompanying drawings. In the drawings:

FIG. 1 (a) schematically illustrates a traditional star network topology.

FIG. 1 (b) shows an example of a connectivity matrix.

FIG. 2 (a) schematically illustrates the derivation of multiple collaboration patterns from a connectivity matrix for a network by a parameter server.

FIG. 2 (b) schematically illustrates information exchanges in terms of a collaboration pattern for each edge device and a vector of losses between the parameter server and the edge devices 1 to N, which are nodes in the network.

FIG. 3 shows an example of an objective function to be optimized such that the network of devices can accomplish the given tasks.

FIG. 4 schematically illustrates the interplay between the optimization of the collaboration patterns of the node devices and the optimization of their local models.

FIG. 5 schematically illustrates a network topology that can be used for non-i.i.d. image classification.

FIGS. 6(a) and 6(b) schematically illustrate that, at convergence, the connectivity matrix reveals intercluster and intracluster communication patterns of the nodes.

FIG. 7 schematically illustrates an example of a result of a clustering-based topology design method for non-i.i.d. data.

FIG. 8 shows a flow chart of the steps of an example of a method for implementation at a device in a network for performing inference for a hierarchy of tasks.

FIG. 9 shows a flow chart of the steps of an example of a method for implementation at a node in a network for performing inference for a hierarchy of tasks.

FIG. 10(a) shows an example of a device that can act as a parameter server as described herein and some of its associated components.

FIG. 10(b) shows an example of a node as described herein and some of its associated components.

FIG. 11 shows top-1 classification accuracy for one client out of five clients used in an experiment.

FIG. 12 shows top-1 classification accuracy for one client out of two clients used in another experiment.

### DETAILED DESCRIPTION OF THE INVENTION

In Federated Learning methods, a main node device in a network, generally termed the parameter server, usually has much larger amounts of memory and processing power than the node devices which act as edge devices in the network, generally termed the client devices, to perform computations and store the results. In addition, the parameter server can orchestrate the communication pattern of the information exchanges that take place in the network throughout the training and inference phases.

The communication pattern of the nodes is termed the network topology. The communication patterns in the network can in some implementations be defined by a connectivity matrix. The collaboration pattern of the devices in the network can therefore be stored as a matrix whose rows and columns indicate and index of the device and which contains the numbers 1 and 0 as its elements. For example, an element equal to 1 at row i and column j indicates that devices i and j exchange information. The value of 0 indicates that the corresponding devices do not communicate in the current round of message exchanges.

In the approach described herein, communication patterns can be determined for devices in a network and in some implementations the devices can advantageously be clustered to perform resource and communication-efficient distributed learning to solve a multi-task inference problem. The result of the clustering is an optimal topology of the network tailored to the specific hierarchy of tasks the system is given to solve in the inference phase.

A network generally comprises multiple nodes. The nodes may be, for example, client devices and/or edge devices. Each node is a connection point in the network and can act as an endpoint for data transmission or redistribution. The parameter server may be one of the nodes (for example, one of the client or edge devices) or may be a separate device in the network. Each node may comprise at least one processor and at least one memory. The memory stores in a non-transient way code that is executable by the processor(s) to implement the node in the manner described herein. The nodes may also comprise a transceiver for transmitting and receiving data.

The parameter server device may also comprise at least one processor and at least one memory. The memory stores in a non-transient way code that is executable by the processor(s) to implement the node in the manner described herein. The parameter server device may also comprise a transceiver for transmitting and receiving data.

The network is preferably a wireless network. In alternative implementations, the network may be a wired network.

The collaboration pattern of the devices in the network is stored at the parameter server as a connectivity model, which in the examples described herein is a connectivity matrix (CM) whose rows and columns indicate and index of the device and which contains the numbers 1 and 0 as its elements. As mentioned above, an element equal to 1 at row i and column j indicates that devices i and j exchange information. The value of 0 indicates that the corresponding devices do not communicate in the current round of message exchanges. The connectivity model may alternatively be another model or data structure that indicates which other node(s) in the network a respective node is to communicate with.

During training, the connectivity matrix can change its contents according to the changing pattern of communication between the nodes, until convergence is reached. This can happen when any new change in the collaboration patterns of the nodes does not bring any significant improvement in the objective function used to measure the performance of the network in achieving the given tasks.

A network can be trained so that in the inference phase, the node devices in the network can perform multi-task inference for multiple tasks in a hierarchy of tasks. For example, in an image classification problem, the hierarchy of tasks may comprise the following:
the first level: the task is to classify the image into the correct class, one out of C classes
the second level: after the correct class is identified, the task is to classify the objects in the image into their correct sub-class.
the third level: after each object in the image is correctly identified, the task is to identify their specific attributes.

Such networks may be trained to perform other types of tasks, for example in areas such as natural language processing (NLP), medical imaging, robotics, autonomous driving and neuroscience.

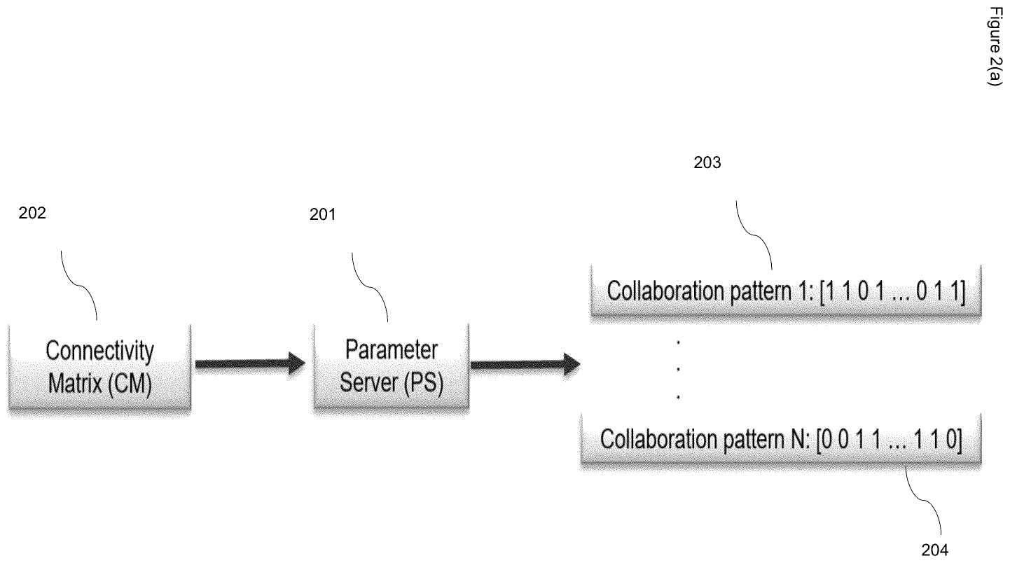

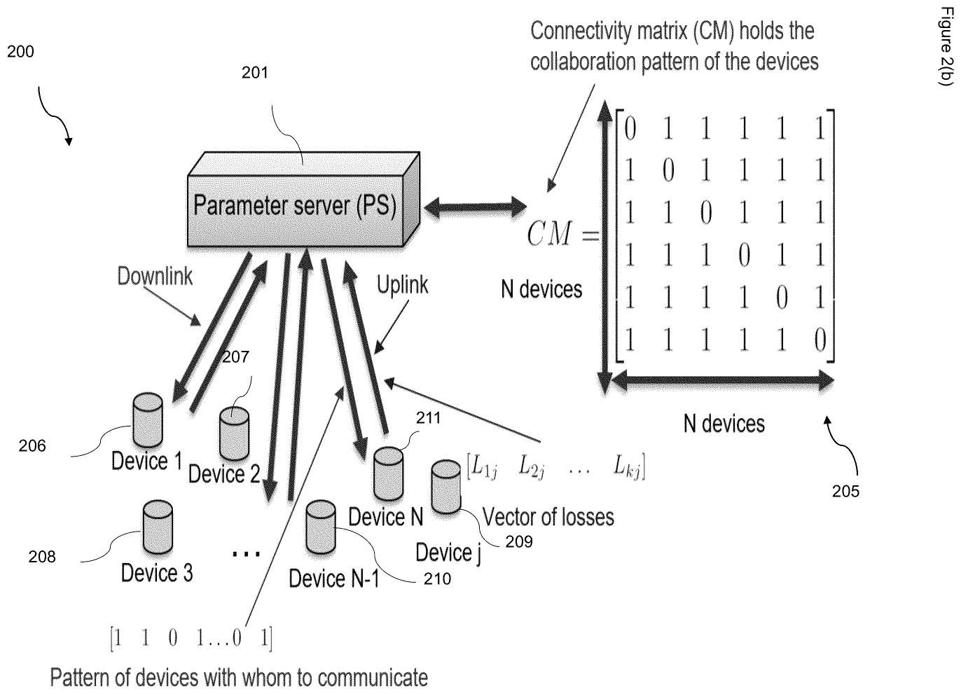

One implementation will now be described with reference to FIGS. 2 (a) and 2 (b).

A parameter server (PS) 201 in the network 200 is chosen. The parameter server may be a device in the network that has a larger amount of memory and processing power than other devices in the network to perform computations and store the results. The parameter server may be a node in the network that also performs data processing in the same manner as the other nodes, or may be a separate device that orchestrates the communication pattern of the information exchanges between nodes that take place in the network throughout the training and inference phases without processing its own data for a particular task.

The PS 201 receives the current connectivity matrix 202 for the network 200 and sends a respective collaboration pattern of indices to each node in the network so that the nodes know which other node(s) in the network they are to communicate with and/or which nodes they are not to communicate with. Two exemplary collaboration patterns derived from the matrix 202 are shown at 203 and 204.

Each collaboration pattern may comprise multiple indices each corresponding to a node i in the network. A value of 1 in the pattern corresponding to a node i indicates that the particular node having that collaboration pattern communicates with node i. A value of 0 in the pattern corresponding to a node i indicates that the particular node having that collaboration pattern communicates with node i.

As shown in FIG. 2 (b) at the start of a first iteration of the process, the connectivity matrix is an initial connectivity matrix 205. The initial connectivity matrix may be a full connection matrix, which defines that each node is to communicate with every other node in the network and has ‘1’ values everywhere apart from the diagonal which has ‘0’ values, which indicate that a node does not communicate with itself. Alternatively, the initial connectivity matrix may have random values.

The PS 201 determines the collaboration patterns for each node from the connectivity matrix and sends a respective collaboration pattern to each node in a downlink message. Node devices 1, 2, 3, j, N-1 and N are shown at 206, 207, 208, 209, 210, and 211 respectively.

Each node device is configured to implement a trained artificial intelligence model, such as a neural network. Weights of the model (which may also be referred to as parameters) may also be updated during each iteration of the process.

During the training phase, each node device is configured to process at least part of a training data set. Each node may be configured to process a sub-set of the training data set. The training data set may comprise multiple pairs of training data each comprising input data and respective expected outputs. In the example of image classification, each item of input data may comprise an image and each expected output may comprise a classification for the respective image which can be compared to the classification result output by the network.

During training, a global loss function for the hierarchy of tasks may be minimized. A gradient is the rate of change of the loss function to the change in a weight of the neural network. During each iteration, every node device computes its respective gradients and sends them to the devices indicated by the collaboration pattern defined by the connectivity matrix 205.

Using the received gradients from the other nodes with whom it was indicated to collaborate, as defined by the connectivity model and derived collaboration patterns, each node averages its own gradients and the received gradients and uses the average to update its respective model. Each node computes a vector of losses corresponding to the tasks in the hierarchy. Each node sends this vector of losses to the PS 201 in an uplink message, as shown in FIG. 2(b).

The parameter server receives the vectors of losses from all of the node devices and computes the average loss for the network. The parameter server updates the connectivity matrix in dependence on the average loss. The parameter server then sends respective new collaboration patterns to each node for the next iteration of the process. The above process can be repeated until the network loss function is minimized.

In summary, using the information from the connectivity model, the parameter server sends a respective collaboration pattern to each of the node. Each node computes its gradients for its respective local model and sends them to the appropriate nodes as defined in the received collaboration pattern. Each node aggregates the received gradients, updates the parameters of its local model and computes the loss. Each node sends their respective loss back to the parameter server. This may be sent as a vector of losses. The parameter server computes the averaged global loss and decides whether the connectivity model is to be changed to further reduce the averaged global loss. The server can update the connectivity model if required. After a step of the connectivity model optimization, each node performs a local model update using their local dataset.

Therefore, the parameter server device sends a respective current collaboration pattern to each node in the network. Each respective current collaboration pattern is derived from the current connectivity model, for example a current connectivity matrix, for the network indicating which other node(s) in the network a respective node is to communicate with. The parameter server receives a respective vector of losses corresponding to the hierarchy of tasks from each node in the network. The parameter server then updates the connectivity model for the network in dependence on the received respective vectors of losses. Each node device receives a current collaboration pattern from the parameter server device in the network. Each node devices determines one or more gradients of the respective neural network implemented by the node. Each node sends the one or more gradients to one or more other nodes in the network indicated by the current collaboration pattern. Each node determines a vector of losses corresponding to the hierarchy of tasks and send the vector of losses to the parameter server device.

As mentioned above, each node is configured to implement a model, such as a neural network. In a preferred embodiment, the nodes do not exchange raw input data in order to preserve privacy, but they exchange features of their neural networks, such as the gradients, in order to allow for model and performance improvement. Therefore, in some implementations, for privacy or other reasons, nodes may send only the output of the respective model that they implement, not the raw data itself. The raw data is input to the model. The model may be configured to encrypt the input data. As the nodes do not share their raw data (i.e. their data before processing using the respective model implemented by a respective node), they have no means of deciding before the training phase whom to communicate with to improve their task performance.

During the inference phase, each node has access only to data similar to that of the training phase. Thus, training with data from other nodes having different distributions may not be beneficial.

Due to the non-i.i.d. nature of typical real world data and the heterogeneity of the tasks that are performed by different nodes in the network, aggregating the information from all the nodes may in some cases reduce the task performance. Finding the optimal topology has the benefit of reducing the communication cost between the nodes at inference time, as well as increasing the task performance, because certain subsets of the data are suitable for certain tasks and not for all of them.

Non-linear optimization methods can be applied to the process of updating the connectivity matrix for the network, such that the global average training loss is minimized. The connectivity matrix of the nodes in the network can be changed until the best pattern is obtained for the nodes to exchange gradients, i.e. until convergence.

In a preferred implementation, finding the optimal network topology involves two alternating minimization steps, both performed by a cooperation between the parameter server and the node devices.

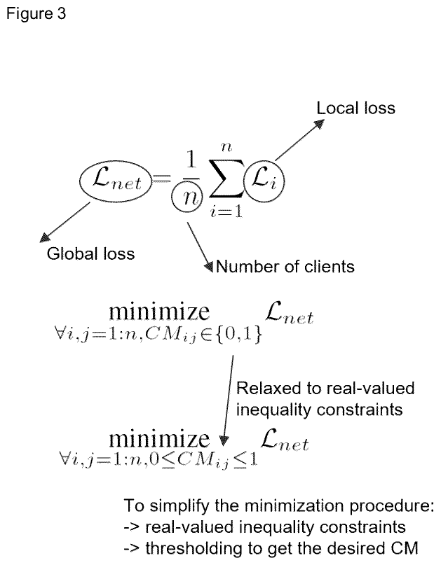

Minimization of the global average objective function (global loss) over the connectivity matrix for the network may be performed using Sequential Least Squares Programming with inequality constraints. An exemplary loss function and formulation of the non-linear optimization procedure to determine the connectivity matrix (CM) is shown in FIG. 3, where Lₙₑₜ is the global loss, n is the number of nodes (clients) and Li is the local loss.

The global average objective function (global loss) is minimized over the training data. This may be performed using methods such as stochastic gradient descent (SGD) with backpropagation. The global loss can be optimized such that the network of node devices can accomplish the given tasks.

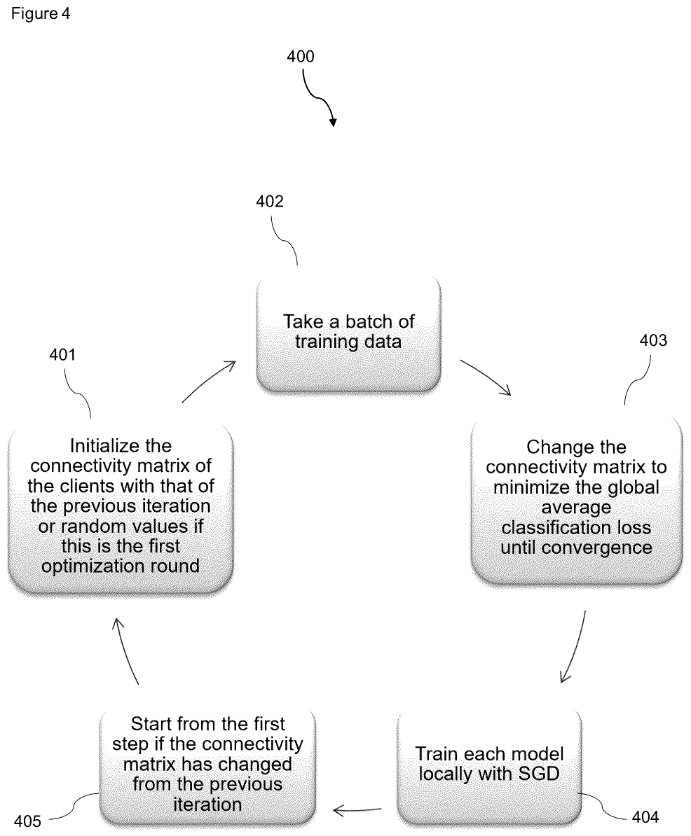

FIG. 4 shows the interplay between the optimization of the collaboration patterns of the devices and that of their local neural networks to find the optimal network topology through these two alternating optimization (minimization) steps.

The two optimization steps are performed at the same time: the update of the parameters of the modes implemented by each node device and finding the best collaboration pattern of the communication between node devices. These optimization steps are performed jointly, as each of them affects the performance of the other. The correct balance between how often the two steps are performed can be determined as a salient feature of the optimization algorithm.

At 401, the connectivity matrix is initialized with the connectivity matrix determined in the previous iteration, or with an initial matrix having random values or a full connectivity matrix if this is the first optimization iteration. At 402, a batch of training data is received by the network and an iteration of the above-described process is performed. At 403, the current connectivity matrix is updated to minimize the global average classification loss. This is done after each iteration until convergence. As indicated 404, the model implemented by each node device is trained locally, for example using SGD. The parameters of the model can be updated after each iteration until convergence. As indicated at 405, if convergence has not yet occurred, the updated connectivity matrix can be used in the next iteration of the process.

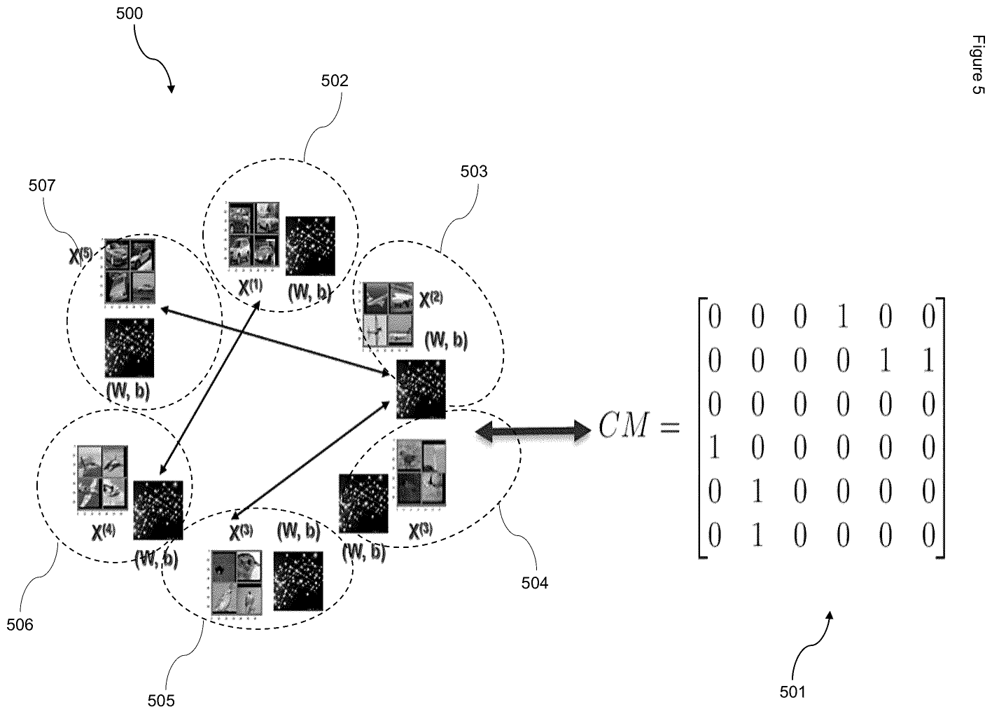

FIG. 5 schematically illustrates communication in a network 500 during the inference phase for a non-i.i.d. image classification task, the final connectivity matrix (CM) 501 having been determined using the process described above. Each node device indexed by i processes a partial dataset denoted as X⁽ⁱ⁾, a local model (in this case a neural network) specified by its weights W and biases b as (W, b). Nodes 1 to 5 of the network are indicated at 502, 503, 504, 505, 506 and 507 respectively. The arrows indicate the communication pattern between the nodes in the network, which is also given numerically by the connectivity matrix 501. The communication within the nodes to perform the hierarchy of tasks is therefore given by the connectivity matrix 501.

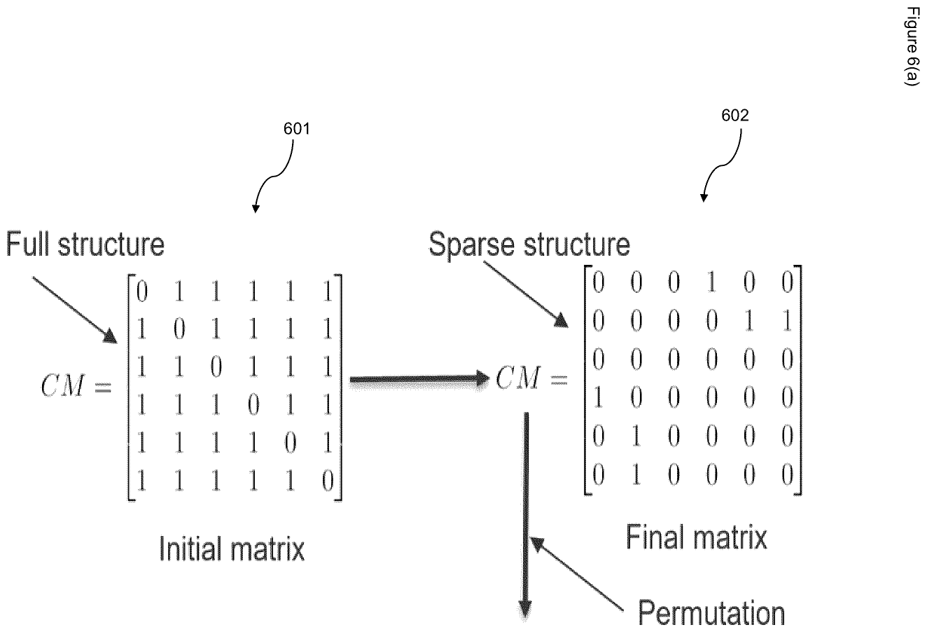

As depicted in FIGS. 6(a) and 6(b), at convergence, the connectivity matrix can define clusters of node devices according to the shared statistical properties of the data processed at each node and the relevant task in the given hierarchy. The connectivity matrix can provide the collaboration pattern within each cluster, as well as which nodes communicate with which other nodes from other various discovered clusters in the network.

The connectivity matrix shown at 601 in FIG. 6(a) is an initial, full connectivity matrix where each node communicates with every other node in the network. The sparse structure shown at 602 is a final connectivity matrix at convergence. The final matrix can optionally undergo further permutations. For example, the final matrix may undergo a further permutation that aims to re-arrange the elements of the matrix in a manner so as to obtain a matrix that is block-diagonal, or nearly-block diagonal. A block diagonal matrix is a matrix in which the diagonal elements are square matrices, as shown within the squares labelled clusters 1, 2 and 3 in matrix 603 of FIG. 6(b).

FIG. 6(b) shows another example of a connectivity matrix 603 where, at convergence, and optionally after applying a permutation to the final matrix obtained during training, the connectivity matrix reveals the intercluster (between clusters) and intracluster (between nodes in the same cluster) communication patterns of the nodes.

The connectivity matrix 603 defines three clusters of nodes; 604, 605 and 606. Each cluster comprises multiple nodes. Cluster 604 comprises four nodes and clusters 605 and 606 each comprise three nodes. Each node in a cluster communicates with each of the other nodes in the cluster (intracluster communication). The nodes of the same cluster process data that is relevant for the same task in the hierarchy of tasks. There may also be communication between clusters of nodes (intercluster communication), as indicated by the circled ‘1’ digits in FIG. 6(b). During the training phase, the clusters can exchange gradients of the neural networks implemented by the nodes in the clusters, as described above. During the inference phase, the clusters can exchange the result of a particular task of the hierarchy of tasks to be solved by the network. A cluster may communicate with another cluster through only one node in each cluster. Therefore, a node in each cluster may be configured to receive data from a node in another cluster. A node in each cluster may be configured to send data to a respective node in one or more another clusters.

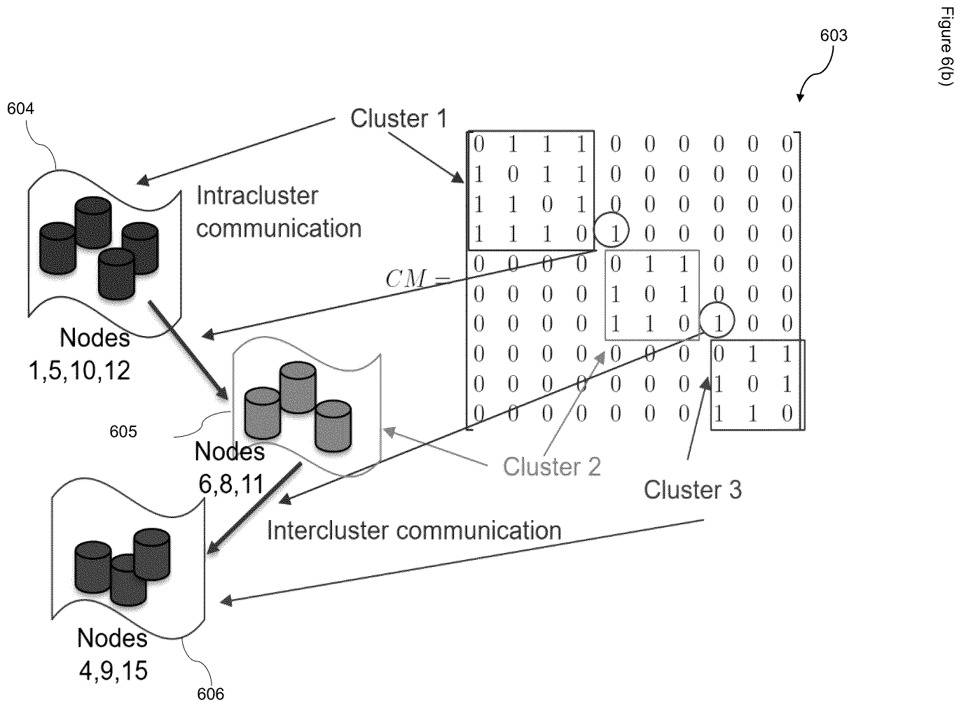

FIG. 7 schematically illustrates an example of a resulting network topology obtained using of the above process, where the multiple nodes in a distributed network 700 have been clustered. The parameter server is not shown in FIG. 7, but the nodes are each configured to receive their respective collaboration patterns from the parameter server and send their respective losses to the parameter server during each iteration of the training process, as described above. Each node may receive its final, optimized collaboration pattern from the parameter server to be used in the inference phase to perform the tasks in the hierarchy of tasks for the input data received by the nodes in the network. The collaboration pattern for each of the nodes to be used in the inference phase is derived from the final connectivity model obtained from the training phase. The collaboration pattern indicates which other nodes in the network a particular node is to communicate with. The network comprises a plurality of clusters of nodes 701, 702, 703, 704, 705, 706. Each cluster comprises multiple nodes. The nodes in a cluster communicate with the other nodes in the cluster (intracluster communication). A cluster of nodes may also communicate with at least one other cluster of nodes (intercluster communication). As mentioned above, during the training phase, the clusters can exchange gradients of the neural networks implemented by the nodes in the clusters. During the inference phase, the clusters can exchange the result of a particular task of the hierarchy of tasks to be solved by the network. In the example shown in FIG. 7, cluster 701 communicates with clusters 702 and 703. Cluster 702 communicates with clusters 704 and 705, as well as cluster 701. Cluster 703 communicates with cluster 706, as well as cluster 701. The nodes in cluster 701 process data that is relevant to a task at the first level of the hierarchy of tasks. The nodes in clusters 702 and 703 receive data from the nodes in cluster 701. A single node in cluster 701 may send data to a single node in each of clusters 702 and 703. Clusters 702 and 703 each process data that is relevant to a task in the second level of the hierarchy of tasks. Clusters 704, 705 and 706 each process data that is relevant to a task in the third level of the hierarchy of tasks. The nodes in clusters 704 and 705 receive data from the nodes in cluster 702. A single node in cluster 702 may send data to a single node in each of clusters 704 and 705. The nodes in cluster 706 receive data from the nodes in cluster 703. A single node in cluster 703 may send data to a single node in cluster 706. At least one cluster of nodes in the network may therefore receive data from one or more clusters of nodes which are at a level above that of the respective cluster in the hierarchy.

In some embodiments, one or more of the following may be true during the training and/or inference phases. The hierarchy of the multiple tasks may be known. A loss function to optimize for each task may be given and known. Each node device may process a sub-set of the data received by the network that is relevant for only one task in the hierarchy of tasks. The data may be non-i.i.d., meaning that it has different statistical properties depending on which node the data is located. Each node device may not know for which task its input data is useful.

The goal of the process is therefore to find the best collaboration patterns for the nodes, such that each node finds the most appropriate neighbouring nodes in the network with whom to exchange information to maximize its own learning ability. The aim is to exchange only information that is relevant for a particular task, so as to reduce the communication cost between the nodes. To this end, the nodes can be grouped into clusters, such that the nodes of the same cluster process data that is relevant/useful for the same task. A node may exchange data only with nodes of the same cluster (intracluster communication), though in some embodiments, clusters of nodes can communicate with one another, as described above (intercluster communication). The method can determine a suitable ordering in terms of intercluster communication from the connectivity matrix.

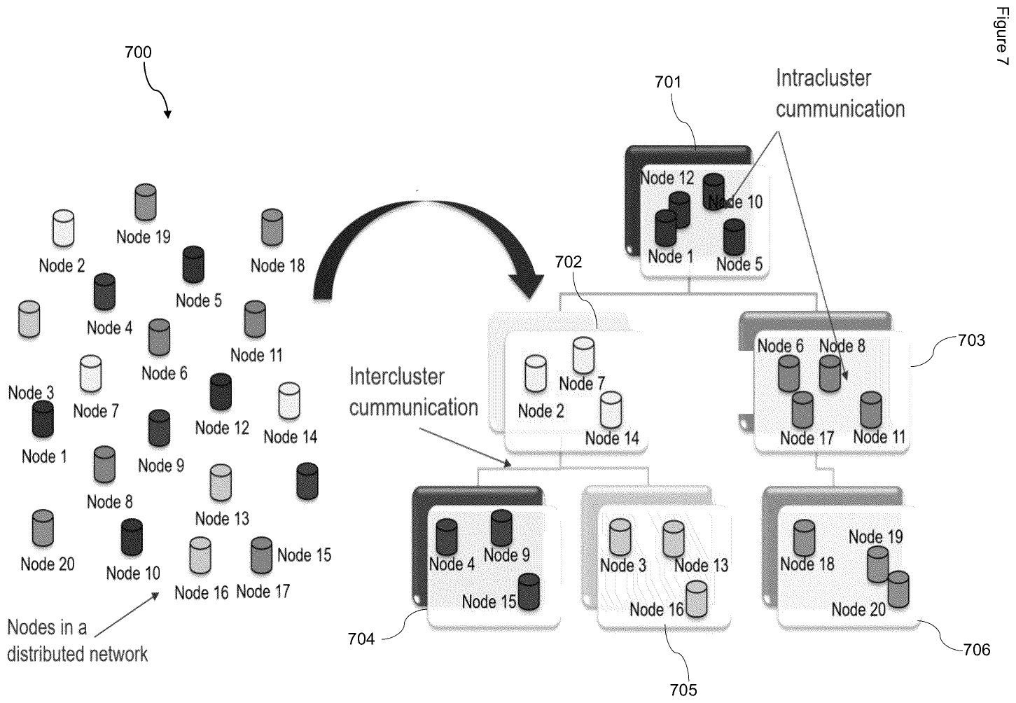

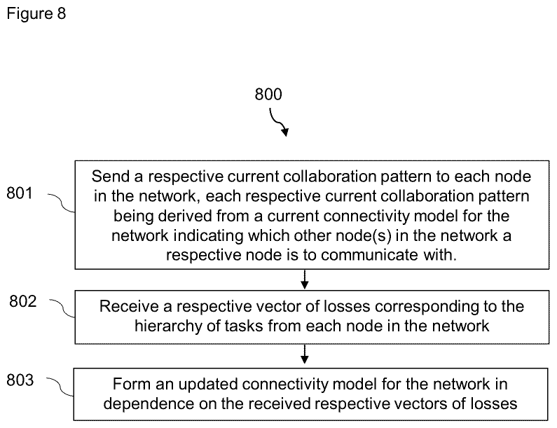

FIG. 8 shows an example of a general method 800 for performing inference for a hierarchy of tasks in a network. The network comprises multiple nodes each configured to process respective data relating to a task of the hierarchy of tasks. The method comprises at step 801, sending a respective current collaboration pattern to each node in the network, each respective current collaboration pattern being derived from a current connectivity model for the network indicating which other node(s) in the network a respective node is to communicate with. At step 802, the method comprises receiving a respective vector of losses corresponding to the hierarchy of tasks from each node in the network. At step 803, the method comprises forming an updated connectivity model for the network in dependence on the received respective vectors of losses.

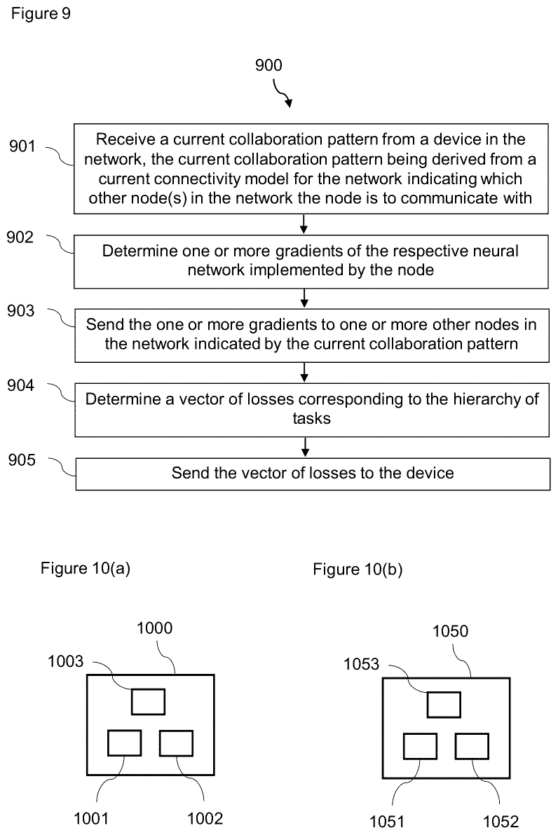

FIG. 9 shows an example of a general method 900 performed at a node in a network for performing inference for a hierarchy of tasks. The network comprises multiple nodes each configured to implement a respective neural network for processing respective data relating to a task of the hierarchy of tasks. The method comprises, at step 901, receiving a current collaboration pattern from a device in the network, the current collaboration pattern being derived from a current connectivity model for the network indicating which other node(s) in the network the node is to communicate with. At step 902, the method comprises determining one or more gradients of the respective neural network implemented by the node. At step 903, the method comprises sending the one or more gradients to one or more other nodes in the network indicated by the current collaboration pattern. At step 904, the method comprises determining a vector of losses corresponding to the hierarchy of tasks. At step 905, the method comprises sending the vector of losses to the device.

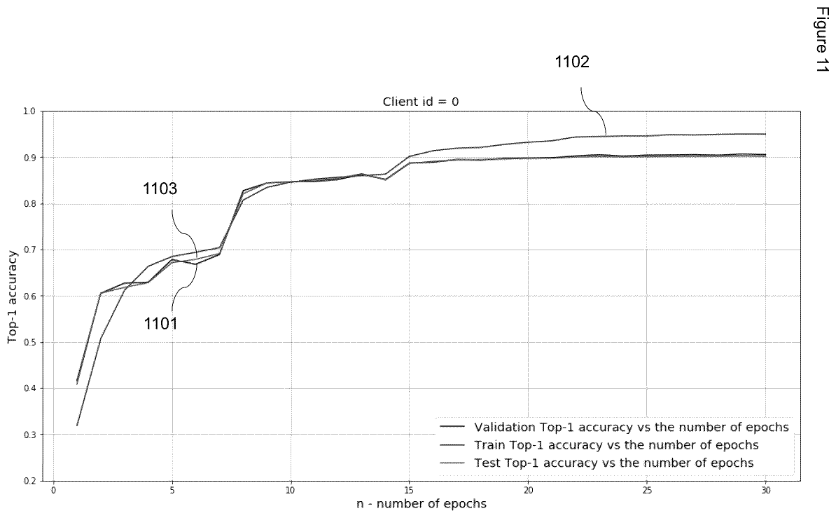

FIGS. 10(a) and 10(b) show examples of devices configured to implement the above methods. FIG. 10(a) shows an example of a device configured to act as the parameter server described above. FIG. 10(b) shows an example of a device configured to act as a node described above. The devices 1000, 1050 may comprise at least one processor, such as processors 1001, 1051 and at least one memory, such as memories 1002, 1052. The memory stores in a non-transient way code that is executable by the processor(s) to implement the device in the manner described herein. The device may also comprise a transceiver 1003, 1053.

Results from one particular embodiment which uses a clustering-based topology design method for non-i.i.d. image classification will now be described. This embodiment is represented by heterogeneous image classification at the nodes. For example, a number N of node devices are to collaboratively train respective local neural network models at each node for image classification.

Each node device has access to a local dataset of images that is non-i.i.d. across the network. Some nodes have images with the same statistical properties, but this information may not be known a-priori by the nodes. That is, the nodes in the network do not know which other nodes have access to the same type of images as they do, or which nodes have access to different types. Therefore, at each node, nothing may be known about the statistical properties of the datasets being processed by the other nodes in the network.

In this example, a parameter server device is designated which orchestrates the distributed learning process, as well as the communication between itself and the nodes and between the nodes themselves. The network is assigned to classify the images into their respective class.

A large training dataset of images is split into N parts of smaller size and is distributed across the network to each of the N nodes. The images belong to C number of classes. Each image belongs to one of the C classes. The non-i.i.d aspect of the data comes from the fact that the classes are distributed unevenly across the network, such that some nodes may have access to only one or a few number of classes in their respective training data, as well as the fact that they do not possess the entire image set that belongs to a class. Thus, each node only has access to a small subset of images from a class and therefore can collaborate with other nodes with similar images to improve its classification performance.

The image classification problem is specified as a hierarchy of tasks as follows. In this example, upon the network receiving an image, the hierarchy of tasks comprises the following:
the first level: the task is to classify the image into the correct class, one out of C classes
the second level: after the correct class is identified, the task is to classify the objects in the image into their correct sub-class.
the third level: after each object in the image is correctly identified, the task is to identify the specific attributes of the objects.

For a preliminary experiment for the task on the first level in the hierarchy, the Canadian Institute for Advanced Research (CIFAR-10) benchmark dataset (see https://en.wikipedia.org/wiki/CIFAR-10) was used to test the performance of classical Federated Learning for image classification with i.i.d data.

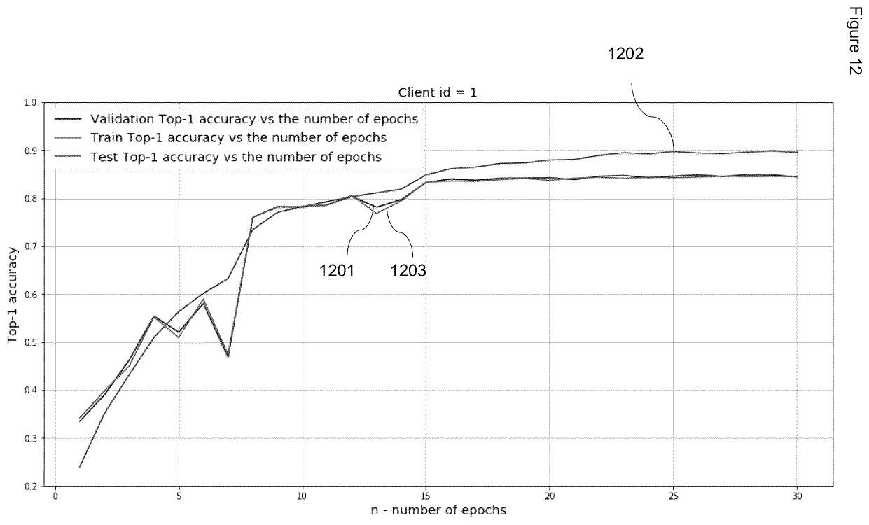

Exemplary results are reported in FIGS. 11 and 12 as top-1 classification accuracy, which refers to the fact that the predicted class by the neural network classifier is identical to the original class. The number of epochs refers to the number of times the entire dataset is passed to the neural network model for training. Training is performed with SGD with momentum and weight decay, the learning rate is equal to 0.1 and the batch size is equal to 24.

FIG. 11 shows the Top-1 classification accuracy for one node device out of five node devices used in this experiment. The validation accuracy is indicated at 1101, with the train and test accuracies indicated at 1102 and 1103 respectively. Each node uses the entire CIFAR-10 dataset for training. The parameter server aggregates and averages the gradients and the nodes and parameter server exchange gradients. The Resnet-18 architecture is used for the classification of the CIFAR-10 images.

FIG. 12 shows the Top-1 classification accuracy for one node device out of two node devices used in this experiment. The validation accuracy is indicated at 1201, with the train and test accuracies indicated at 1202 and 1203 respectively. Each node has half of the CIFAR-10 dataset for training. The parameter server aggregates and averages the gradients and the nodes and parameter server exchange gradients. The Resnet-18 architecture is used for the classification of the CIFAR-10 images.

As illustrated in FIGS. 11 and 12, even in the simple case when less data is available at the nodes, the image classification accuracy significantly drops. However, using the approach described herein can result in improved classification accuracies relative to previous techniques using distributed learning.

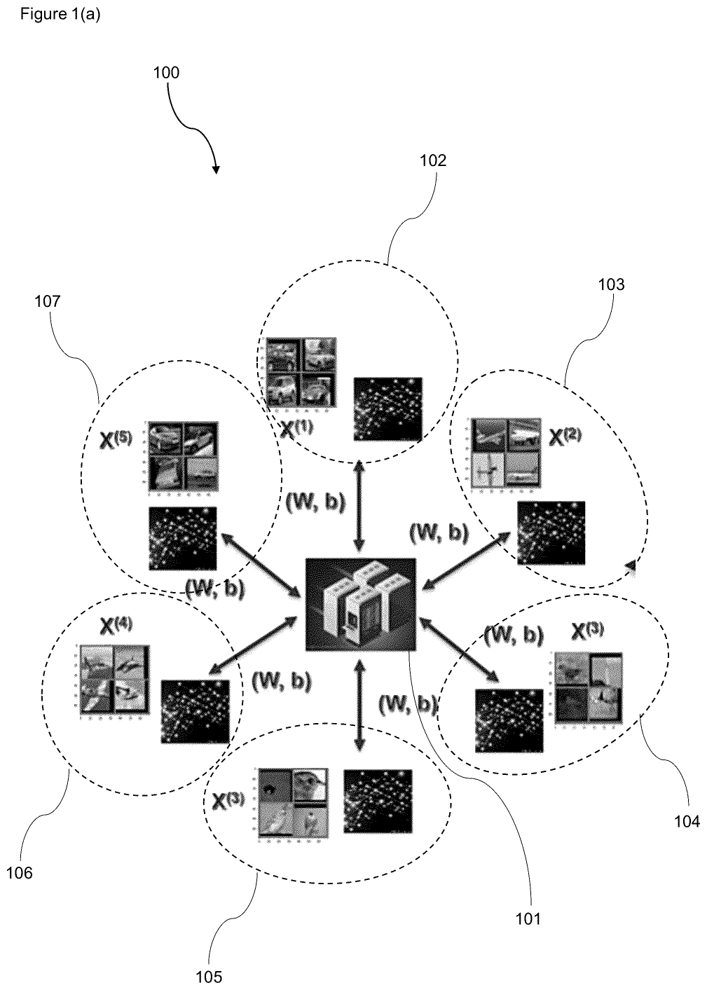

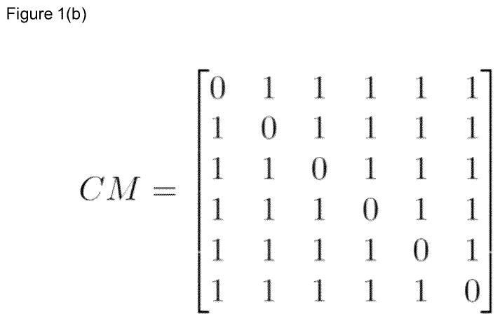

The star topology (FIG. 1), which is the state-of-the-art approach in the literature, can be highly suboptimal in the case of non-i.i.d. data. Improved performance can be obtained if the traditional star topology is replaced with a customized topology for each particular use-case where distributed learning is employed.

Even for a small number of nodes in a network, there is an exponential number of possible topologies. The approach described herein provides an efficient search method to find the optimal topology for a given hierarchy of tasks. The approach can be used in image classification applications to provide a customized network topology, which can ensure the highest possible accuracy of image classification on each device. The approach can also address the non-i.i.d. and private nature of data and multitask inference.

Some further advantages of the approach described herein include the following.

At inference time, only a few devices communicate with each other in a given cluster, which entails an overall significant reduction in the communication cost in the network, leading to improvements such as energy savings and prolonged battery life for the edge devices. This feature is a result of the sparse nature of the connectivity matrix. This reduction is further enhanced by the fact that clusters can communicate between each other through only one node. The network obtains increased performance on the tasks, as each discovered cluster is tailored to a particular task from the hierarchy of tasks given at the beginning of the optimization procedure.

In addition, each cluster of nodes is obtained in such a way as to exploit the data that has similar statistical properties and pertains to a specific task from the hierarchy. This may result in improved inference performance and communication efficiency. The latter is achieved because only devices that have relevant data can exchange information between them and not with other nodes for which such data would not be beneficial for their particular learning task.

Furthermore, the hierarchical nature of the obtained topology makes the information flow in the network efficient and energy saving. Advantageously, data remains private at each client, because the clients can be trained indirectly through the clustering and optimization method and not through the direct exchange of raw data. The method is scalable to a large number of nodes.

The network topology design method described herein is given by an optimization procedure that alternates between optimizing the collaboration pattern of the devices and that of the neural network models, using classical stochastic gradient descent training on the local dataset. This optimization procedure can induce a clustering of the devices according to the shared statistical properties of the data from the network, as well as fitting to the relevant task in the hierarchy given to the network to solve.

The optimization procedure can involve an interplay between selecting the best collaboration pattern of the devices and updating the model parameters of the local neural networks at the devices. This can allow for the local neural networks on the edge devices to be trained indirectly, without exchanging raw data, thus preserving privacy. This can be an important feature in complex real-world applications, where the privacy of the end-user is highly desirable.

This approach addresses collaborative distributed learning by a given number of client devices in a network orchestrated by a parameter server, such that task performance and communication cost are optimized. The approach can be used to find the optimal network topology to perform multitask inference when a hierarchy of the tasks is known and the data at each node is non-i.i.d. and private. As a result, the approach can assist the clients to find the best way to gather and send out information in the network, so as to solve a multitask problem given to the entire network.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

What is claimed is:

1. A device in a network for performing inference for a hierarchy of tasks, the network comprising multiple nodes each configured to process respective data relating to a task of the hierarchy of tasks, the device being configured to:
send a respective current collaboration pattern to each node in the network, each respective current collaboration pattern being derived from a current connectivity model for the network indicating which other nodes in the network a respective node is to communicate with;
receive a respective vector of losses corresponding to the hierarchy of tasks from each node in the network; and
form an updated connectivity model for the network in dependence on the received respective vectors of losses.

2. The device as claimed in claim 1, wherein each respective vector of losses is determined in dependence on one or more gradients of respective neural networks implemented by a respective node in the network and each of the nodes in the network that are configured to communicate with the respective node according to the current connectivity model for the network.

3. The device as claimed in claim 1, wherein the updated connectivity model defines multiple clusters of nodes, wherein each node in a cluster is configured to communicate with other nodes in that cluster.

4. The device as claimed in claim 3, wherein the updated connectivity model defines an inter-cluster collaboration pattern for each of the multiple clusters of nodes.

5. The device as claimed in claim 3 wherein the nodes of a cluster are each configured to output data that is relevant for a same task of the hierarchy of tasks.

6. The device as claimed in claim 1, wherein the respective data processed by each node in the network is non-independent and identically distributed data having different statistical properties depending on which node in the network the data is processed by.

7. The device as claimed in claim 1, wherein the device is configured to:
combine the respective vectors of losses received from each of the nodes in the network to determine a value of combined losses; and
form the updated connectivity model in dependence on the value of combined losses.

8. The device as claimed in claim 1, wherein the device is configured to form the updated connectivity model so as to minimize a global average training loss for the hierarchy of tasks.

9. A node in a network for performing inference for a hierarchy of tasks, the network comprising multiple nodes each configured to implement a respective neural network for processing respective data relating to a task of the hierarchy of tasks, the node being configured to:
receive a current collaboration pattern from a device in the network, the current collaboration pattern being derived from a current connectivity model for the network indicating which other nodes in the network the node is to communicate with;
determine one or more gradients of the respective neural network implemented by the node;
send the one or more gradients to one or more other nodes in the network indicated by the current collaboration pattern;
determine a vector of losses corresponding to the hierarchy of tasks; and
send the vector of losses to the device.

10. The node as claimed in claim 9, wherein the node is configured to:
receive one or more gradients of the respective neural network(s) implemented by one or more other nodes in the network as defined by the current connectivity model for the network; and
determine the vector of losses corresponding to the hierarchy of tasks in dependence on the received one or more gradients.

11. The node as claimed in claim 10, wherein the node is configured to update parameters of its neural network in dependence on the one or more gradients received from the one or more other nodes in the network as defined by the current connectivity model for the network.

12. The node as claimed in claim 9, wherein the node is configured to receive an updated collaboration pattern from the device, the updated collaboration pattern indicating other nodes in a cluster with which the node is to communicate.

13. The node as claimed in claim 12, wherein the node is configured to send a output of its neural network to the other nodes in the cluster indicated by the updated collaboration pattern.

14. The node as claimed in claim 9, wherein the node is configured to process data relevant to a task in the hierarchy of tasks.

15. The node as claimed in claim 9, wherein the data processed by the node is non-independent and identically distributed data having different statistical properties to data processed by one or more other nodes in the network.

16. A non-transitory computer-readable storage medium, wherein storage medium coupled to one or more processors and storing programming instructions for execution by the one or more processors, the programming instructions instruct the processor to:
send a respective current collaboration pattern to each node in network, each respective current collaboration pattern being derived from a current connectivity model for the network indicating which other nodes in the network a respective node is to communicate with;
receive a corresponding vector of losses from each node in the network; and
form an updated connectivity model for the network in dependence on the received respective vectors of losses.

17. A non-transitory computer-readable storage medium, wherein storage medium coupled to one or more processors and storing programming instructions for execution by the one or more processors, the programming instructions instruct the processor to:
receive a current collaboration pattern from a device in network, the current collaboration pattern being derived from a current connectivity model for the network indicating which other nodes in the network the node is to communicate with;
determine one or more gradients of corresponding neural network implemented by the node;
send the one or more gradients to one or more other nodes in the network indicated by the current collaboration pattern;
determine a vector of losses corresponding to the neural network; and
send the vector of losses to the device.
